(19) United States
(12) Patent Application Publication
(10) Pub. No.: US 2012/0168116 A1
(43) Pub. Date: Jul. 5, 2012

(54) METHOD OF CONSTRUCTING A WIND TURBINE AND BOTTOM TOWER SECTION OF WIND TURBINE

(75) Inventors: Marianna Mello, Barcelona (ES); Bonne Dijkstra, Arum (NL); Franciscus Leonardus Hendricus Strik, Amerongen (NL); Jan Willem Pasteuning, Amsterdam (NL)

(73) Assignee: XEMC Darwind B.V., Hilversum (NL)

(21) Appl. No.: 13/255,613

(22) PCT Filed: Mar. 12, 2010
(86) PCT No.: PCT/EP10/53215

§ 371 Date: Dec. 19, 2011

(30) Foreign Application Priority Data
Mar. 13, 2009 (EP) 09155161.4

(51) Int. Cl. F24H 3/00; E04H 12/00; E04H 14/00; B23P 11/00

(52) U.S. Cl. 165/47; 29/592.1; 52/651.01; 52/173.1

(57) ABSTRACT

Method of constructing a wind turbine comprising a tower with a bottom section housing electric equipment, which is built in the bottom tower section before the bottom tower section is positioned on a foundation. Prefabricated bottom tower section for a wind turbine comprising electric equipment, e.g., positioned on two or more floors.

### CROSS-REFERENCE TO RELATED APPLICATION

This application is a Section 371 National Stage Application of International Application PCT/EP2010/053215, filed Mar. 12, 2010 and published as WO/2010/103114 in English.

### BACKGROUND

The discussion below is merely provided for general background information and is not intended to be used as an aid in determining the scope of the claimed subject matter.

An aspect of the invention relates to a method for constructing a wind turbine comprising a tower and electric equipment located in the bottom section of the wind turbine tower. An aspect of the invention also relates to a bottom tower section of the wind turbine, and to a wind turbine comprising such a bottom tower section.

Wind turbines are built by first providing a foundation on which subsequently a tower is erected. A gondola or nacelle is then placed on top of the tower. The required equipment is placed in the nacelle or in the tower and rotor blades are attached to a hub carried by the nacelle. In gearless wind turbines of the direct-drive type—such as the turbine disclosed in DE4402184—a generator may be placed between the nacelle and the rotor hub.

Wind turbines contain electric equipment, such as transformers, switch cabinets, possibly inverters, a medium-voltage system, a low-voltage distribution, etc. Such equipment is generally located in the nacelle or in a separate building or container. However, particularly on offshore locations, it is advantageous to locate such equipment within the tower.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

A method of constructing a wind turbine comprising a tower with a bottom section housing electric equipment, includes building electric equipment in the bottom tower section before the bottom tower section is positioned on a foundation.

Modular construction of wind turbine towers using cylindrical or slightly conical sections to be placed on top of each other is typically carried out with large sections that are too high for transportation in their upright position. For multi-MW turbines such sections are typically substantially larger than 10 m. Such modular sections are transported horizontally to be erected at the building site. Electrical equipment, in particular the converter and transformer, should preferably not be transported in an overturned position. The bottom tower section herein described can be a compact module suitable for transportation in its upright position without damaging the electrical equipment. The bottom tower section can, e.g., have a diameter/height ratio of about 1:1 to about 1:1.5 or 1:2. The height of the bottom tower section will be sufficient to encase the equipment it should contain. For a multi-MW offshore wind turbine the height of the bottom tower section can for instance be about 5 meters or more, e.g. 6-10 meters, e.g., about 8 meters.

The method herein described is particularly advantageous for application on offshore locations. The electric equipment can be built-in on an onshore building site safe from saline air and moisture. The offshore building activities needed to install the electric equipment are minimized. Even testing of the equipment can take place onshore before shipment of the module. The bottom tower section with the built-in power module can easily be transported by boat and positioned onto an offshore foundation. After positioning the bottom tower section with the built-in electric equipment, e.g., by a crane, the rest of the tower and the wind turbine can be erected.

Optionally, the foundation includes a monopile or other support structure capped with a transition piece for connecting the tower to the monopile or other support structure. Such a transition piece typically also carries a maintenance platform.

The electrical equipment can be placed on one or more floors supported by the wall of the bottom tower section. In such case the wall of the section forms the structural part carrying the equipment. To this end, the wall of the section may be enforced. It may for instance have a thickness which is 1.2 times or more thicker than the wall thickness in the other parts of the tower wall. It may for instance have a steel wall of at least 5 cm, e.g., 6 cm thickness or more. The floors may for instance be carried by joists or girders attached to the tower wall, e.g. by welding. To prevent entrance of outside saline air and moist the floors can be made substantially airtight. Optionally, the rooms in the bottom tower section can be pressurized. One or more dehumidifiers can be used to maintain relative humidity at acceptable levels.

The electric equipment may include a transformer, one or more auxiliary transformers, a converter, a PLC unit, a UPS, an emergency switch, a low voltage distributor and/or a medium voltage switch cabinet, or further electric equipment and possible non-electrical equipment.

The equipment does not need to be placed in a container before placing it in the bottom tower section. This allows more efficient dissipation of heat generated by the equipment. It also creates more work space, e.g., during assembly, service or maintenance.

After positioning the bottom tower section with the electric equipment, it forms a protected environment for laying and connecting cables, adjustment of individual control modules, outfitting of the switch cabinets and for further operational preparation of the wind turbine.

In a specific embodiment, the bottom tower section can comprise two or more floors and one or more doors allowing access to one of the floors. This enables placement of the transformer and the converter on different floors. The transformer can for example be positioned on the floor which is accessible via the door, while the converter can be positioned on another floor. The door can be dimensioned in such a way that the transformer and optionally also the other present electric equipment can be passed through it, e.g., for maintenance, repair or replacement.

Optionally, the bottom tower section can comprise an annular pathway flanging inwardly at a distance below the upper edge of the bottom tower section. This distance can be such that the upper edge of the bottom tower section, which is for example provided with a flange for providing a connection with higher tower sections, is within reach of workers.

After erecting the wind turbine tower, the bottom section forms an integral part of the tower, e.g., having its outer wall in line with the outer wall of the other tower sections or segments. The outer wall will generally be cylindrical, but can also have any other suitable shape, if so desired.

The wall of the bottom tower section can for example be made of corrosion protected steel, concrete or combinations thereof or any other suitable materials.

To dissipate heat generated by the electrical equipment one or more heat exchangers can be used, cooling the interior air to outside air or to another cooling medium, such as seawater. One or more heat exchange elements can for example be attached to the outside wall of the bottom tower section. Alternatively, or additionally, one or more heat exchangers can be placed in higher tower sections. Such heat exchangers can for instance be cross flow heat exchangers. Via an inlet in the tower wall outside air flows via the cross flow heat exchange module to an air outlet in the tower wall, without contacting interior air.

### BRIEF DESCRIPTION OF THE DRAWING

Aspects of the invention are further explained with reference to the accompanying drawing. In the drawing:

FIG. 1: shows a bottom tower section comprising a power module for use in a method herein described;

FIG. 2: shows a second embodiment of a bottom tower section;

FIG. 3: shows a third embodiment of a bottom tower section.

### DETAILED DESCRIPTION OF THE ILLUSTRATIVE EMBODIMENT

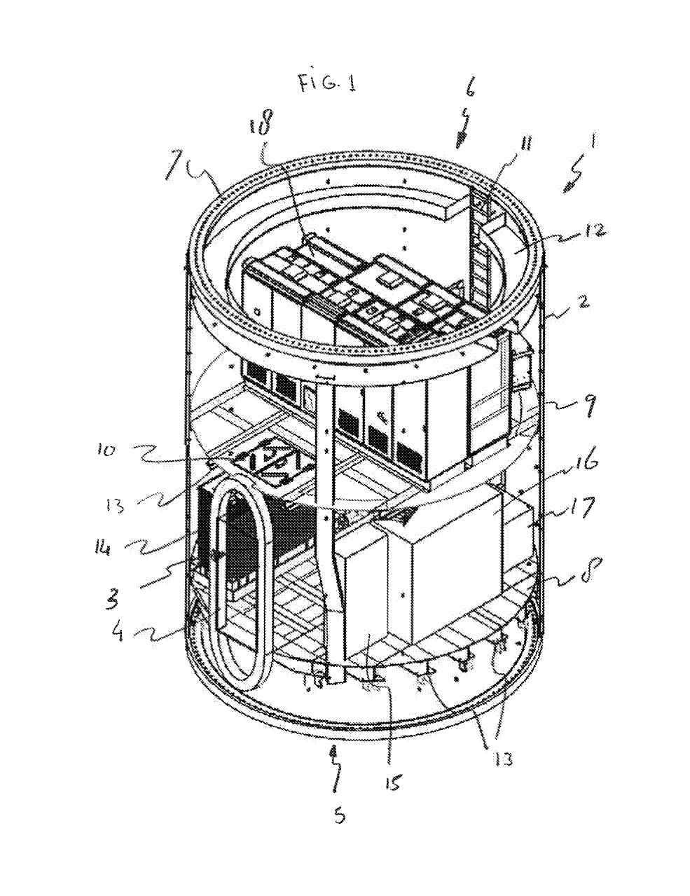

FIG. 1 shows in perspective view a bottom section 1 of a wind turbine tower. The bottom section 1 comprises a cylindrical wall 2 built of steel wall segments, in the drawing shown as transparent parts. The bottom tower section comprises a door opening 3 with a door 4. The lower end 5 of the bottom tower section 1 can be positioned on a foundation, such as a monopile at an offshore location. The upper end 6 of the bottom tower section 1 comprises a flange 7 to join the bottom section 1 to further tower sections, after the bottom section 1 is positioned on the foundation.

In the interior of the bottom tower section 1 are two floors 8, 9. The lower floor 8 is accessible via the door opening 3. The upper floor 9 is accessible from the lower floor 8 via a hatch 10. The lower floor 8 also comprises a hatch (not shown) to the space below the bottom tower section 1 to give access, e.g., to bolts of flange connections. A ladder 11, attached to the inner side of the wall 2 leads from the upper floor 9 to an annular pathway 12 flanging inwardly from the wall 2. Further ladders can be present to floors in higher tower sections or to the nacelle of the wind turbine (not shown). The floors 8, 9 rest on steel I-beams 13.

A transformer 14 is positioned on the first floor 8. A control cabinet 15, a switchgear 16 and a pump unit 17 stand opposite to the transformer 14. A converter 18 is positioned upon the second floor 9.

The door opening 3 is dimensioned in such a way that the transformer 14, the control cabinet 15, switchgear 16 and pump unit 17 can be passed through it, e.g., for maintenance, repair or replacement.

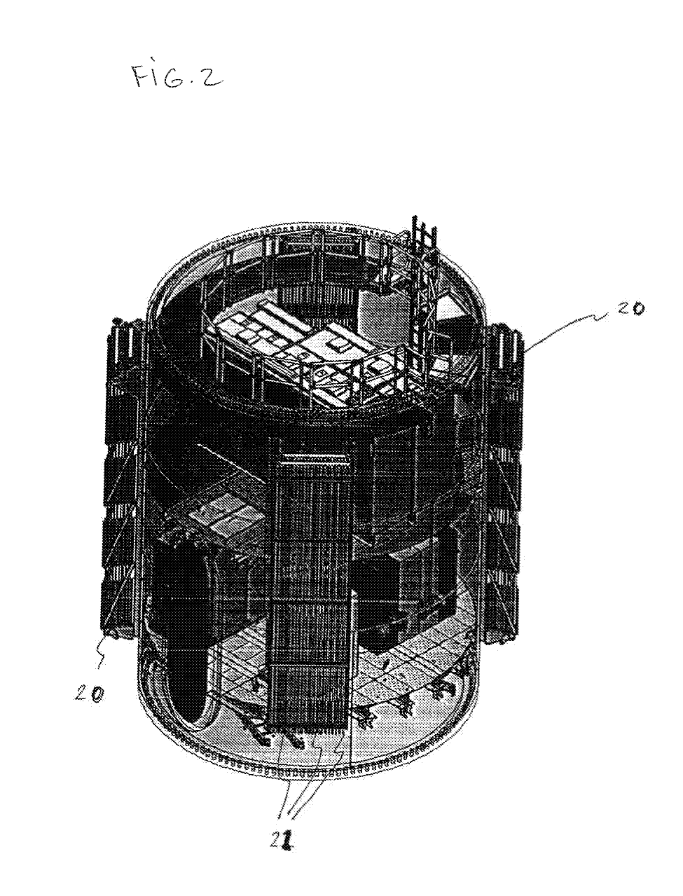

FIG. 2 shows an alternative embodiment of the bottom tower section, which is similar to the embodiment of FIG. 1, with the difference that it is provided with four heat exchangers 20 for cooling interior air to the outside air. To this end interior air is circuited through conduits 21 in the heat exchanger.

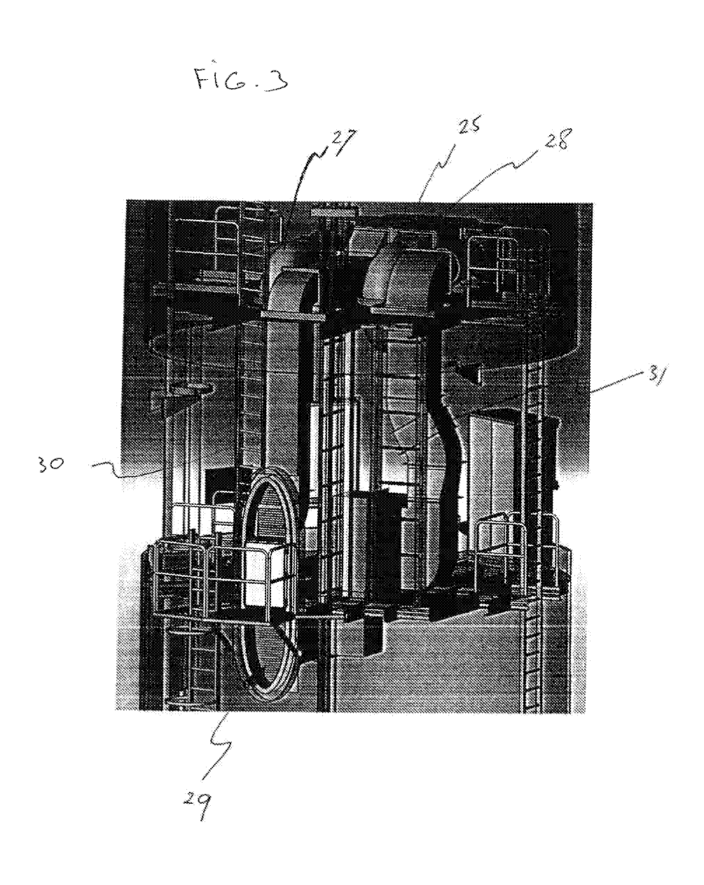

FIG. 3 shows a further possible embodiment with an interior cross flow heat exchanger 25 in an adjacent higher tower section 26. A first duct 27 transports hot air from the transformer room to the cross flow heat exchanger 25. A second duct 28 returns the cooled air to the transformer room. The tower wall comprises an inlet 29 connected to a duct 30 for transporting cool exterior air to the cross flow heat exchanger 25. A return duct 31 returns the used exterior air to the inlet 29. In the cross flow heat exchanger 25, the exterior air cools the hot air from the transformer room via heat exchange surfaces without mixing into the hot air.

The inlet 29 will generally be provided with a grill (not shown) and a filter (not shown) downstream to the grill. Fans can be used to force the airflow through the cross flow heat exchanger 25.

1. A method of constructing a wind turbine comprising a tower with a bottom section housing electric equipment wherein characterized in that the electric equipment is built in the bottom tower section before the bottom tower section is positioned on a foundation, and that subsequently the rest of the tower is erected upon the bottom tower section.

2. The method according to claim 1 wherein the electrical equipment is placed on one or more floors supported by the wall of the bottom tower section.

3. The method according to claim 1 wherein the electric equipment includes a transformer, a control cabinet, a converter, an emergency switch, a low voltage distributor and/or a medium voltage switch cabinet.

4. The method according to claim 1 wherein after building in the electric equipment, the bottom tower section is transported by boat and positioned onto an offshore foundation.

5. A prefabricated bottom tower section for a wind turbine comprising electric equipment on one or more floors supported by an outer wall.

6. The bottom tower section according to claim 5 wherein the bottom tower section comprises one or more doors allowing access to one or more of the floors.

7. The bottom tower section according to claim 6 wherein a transformer is positioned on a first floor which is accessible via the door and a converter is positioned on a second floor.

8. The bottom tower section according to claim 7 wherein the floor with the transformer also carries a control cabinet and/or a switch cabinet and/or a pump unit.

9. The bottom tower section according to claim 5 wherein the bottom tower section comprises an annular pathway flanging inwardly at a distance below the upper edge of the bottom tower section.

10. The bottom tower section according claim 5 wherein the exterior of the bottom tower section is provided with heat exchangers thermoconductively connected to the interior air.

11. The bottom tower section according claim 5, and further including a higher tower segment supported by the bottom tower section and one or more cross flow heat exchangers provided within the higher tower segment comprising heat exchange surfaces and ducts configured to guide an airflow from the bottom tower section along one side of the heat exchange surfaces and ducts configured to guide exterior air from an inlet in the tower wall along another side of the heat exchange surfaces to an outlet in the tower wall.

12. The bottom tower section according to claim 11 wherein the inlet is provided with a grill and/or a filter.
